(19) United States
(12) Patent Application Publication
(10) Pub. No.: US 2011/0265647 A1
(43) Pub. Date: Nov. 3, 2011

(54) METHOD FOR PURIFICATION OF CARBON DIOXIDE USING LIQUID CARBON DIOXIDE

(76) Inventors: Rasmus Find, Vejle (DK); Jan Flensted Poulsen, Vorbasse (DK)

(21) Appl. No.: 13/054,453

(22) PCT Filed: Jul. 3, 2009
(86) PCT No.: PCT/DK2009/050159

§ 371 Date: Feb. 17, 2011

(30) Foreign Application Priority Data
Jul. 16, 2008 (DK) PA200801006

(51) Int. Cl. B01D 53/14; B01D 53/26; B01D 53/18

(52) U.S. Cl. 95/153; 95/237; 95/239; 95/204; 96/243; 96/361; 96/355

(57) ABSTRACT

The present invention relates to a method for removing at least one contaminant from a gaseous stream substantially comprising carbon dioxide. More specifically said method comprising the step of subjecting the gaseous stream to an absorption step in which the absorbent is liquid carbon dioxide.

The present invention relates to a method for removing at least one contaminant from a gaseous stream substantially comprising carbon dioxide. More specifically, said method comprises the step of subjecting the gaseous stream to an absorption step in which the absorbent is liquid carbon dioxide.

### BACKGROUND OF THE INVENTION

Carbon dioxide recovery plants are widely used to clean and/or recover carbon dioxide released e.g. from combustion of hydrocarbons, fermentation and gas processing. Such plants often comprise an absorption step using a chemical or physical absorbent; in the absorption step major impurities are removed. The carbon dioxide gas leaving the absorber is subjected to further downstream purification steps if intended for use in e.g. the food and beverage industry or Enhanced Oil Recovery (EOR).

When producing food grade carbon dioxide or carbon dioxide for other applications, where a high purity is required, further contaminants must be removed in up and/or down stream equipment in order to obtain the required purity. Conventional technologies available for removing such contaminants include for example scrubbing, oxidation, adsorption and/or distillation. Also, the introduction of a flash column step between the absorber and the stripper has been reported e.g. in WO 2007/009461 in which NO₂, which is difficult to separate further down stream in the purification process where the carbon dioxide is in liquid form, since NO₂ is almost irreversibly dissolved therein, is removed in a flash column located between an amine absorber and a stripper.

Another purification step for a carbon dioxide containing gas is dehydration. In a dehydration step any water present in the gas is absorbed and thereby removed from the gaseous stream. Also, if any residues of acetaldehyde, volatiles and/or oxygenates are present in the gas, some of these compounds are also removed in the dehydrator, depending on the dehydrator used.

Another purification step is water scrubbing; in a water scrubber all water-soluble contaminants are removed from the gaseous source. The drawbacks of using a water scrubber is the large amounts of clean water used and wastewater formed.

However, if the gas comprises impurities, which are heavily dissolved in carbon dioxide, i.e. primarily non-polar organic compounds and compounds having a boiling point higher than the boiling point of carbon dioxide under the prevailing conditions, these will not be effectively removed from the stream using a water scrubber. For these compounds an adsorption filter, e.g. activated carbon must be used.

In large facilities, a few percent increase in pure carbon dioxide yield is of great economical benefit, even though the last trace amounts of impurities are the most difficult and expensive to remove. Therefore, there is an ongoing need for finding improved processes and parameters resulting in the required high purity carbon dioxide and at the same time at the highest rate of product yield as well as finding more simple methods for securing the required high purity.

### SUMMARY OF THE INVENTION

In one aspect, the present invention relates to a method for removing at least one contaminant from a gaseous feed stream substantially comprising carbon dioxide, said method comprising the step of subjecting the gaseous feed stream to an absorption step using liquid carbon dioxide as the absorbent under conditions providing a carbon dioxide enriched gaseous stream and a contaminant rich liquid stream containing at least 95% (w/w) of the at least one contaminant from the gaseous feed stream, is obtained; preferably is provided a method wherein the at least one contaminant is selected from the group consisting of non-polar organic compounds or compounds having a boiling point higher than the boiling point of carbon dioxide.

Substantially comprising carbon dioxide according to the present invention means a carbon dioxide feed stream comprising more than 80% (w/w) carbon dioxide.

Small impurities can be difficult to remove in a single process step, however the method of the present invention provides recovery of each of the at least one contaminant in the liquid stream by at least 95% and even up to approximately 100.0%.

In a preferred embodiment, the temperature of the gaseous feed stream entering the column is higher than the dew point temperature of carbon dioxide at the prevailing absorption.

Without the wish to be bound by any theory, the ability of carbon dioxide to wash out contaminants in practice seems to depend on the individual boiling point, partial pressure and solubility in the liquid carbon dioxide of the components. Some components will condense due to temperature reduction, given by the specific partial pressure; others will be absorbed in the liquid carbon dioxide due to attractive forces between molecules or a combination of both. Experiments undertaken by the present inventors surprisingly revealed that the ability of carbon dioxide to scrub out different compounds is a combination of both solubility and boiling point, this was illustrated by the fact that non-polar substances was as easily scrubbed out as polar substances, provided their boiling point is higher.

The method of the present invention therefore takes advantage of some of the same principles applied in a water scrubber, namely the attractive forces between polar substances. However, a water scrubber requires huge amounts of water whereas the present invention makes use of carbon dioxide. Additionally, the present invention will not result in any wastewater; the only waste will be minor amounts of liquid carbon dioxide and impurities, which may eventually be partially re-evaporated to further reduce the amount of liquid waste.

Particularly, when operating with a feed gas temperature above the dew point temperature of carbon dioxide at the prevailing conditions, the amount of carbon dioxide condensed by the colder absorbent liquid carbon dioxide will be reduced, and consequently the yield of pure gaseous carbon dioxide is improved.

The impurities to be removed may be selected from substances having a boiling point higher than the boiling point of carbon dioxide and polar substances selected, for example compounds selected from the group consisting of nitrogen compounds, such as NOₓ's, aromatic hydrocarbons, esters, alcohols and volatile oxygenates and a combination thereof.

More particularly the nitrogen compounds may be selected from ammonia and NOx's, such as NO, NO₂ and N₂O.

The aromatic hydrocarbons may be selected from benzene, ethylbenzene, xylene and toluene.

The volatile oxygenates may be selected from dimethyl ether, diethyl ether, propionaldehyde, acetone, methanol, t-Butanol, ethanol, isopropanol, ethyl acetate, methyl ethyl ketone, 2-butanol, n-propanol, isobutanol, n-butanol, and isoamyl acetate.

None of these substances can be removed effectively from a carbon dioxide gas in a carbon dioxide recovery plant using a single operating step of those described in the prior art, and more importantly to a degree which is suitable for high purity carbon dioxide applications, such as food grade quality carbon dioxide.

As it has not previously been reported that the above-mentioned broad range of contaminants can be removed from carbon dioxide in one single step, the present invention surprisingly provides a more simple, space-saving way of reducing the presence of many different contaminants, such as remaining in trace amounts, from a carbon dioxide stream with a high carbon dioxide yield.

A further advantage of the present invention is that if any NOx's are present in the gaseous stream, NO₂ will also be absorbed in the liquid carbon dioxide, whereby the gas phase equilibrium ½O₂+NO<->NO₂ is forced towards right i.e. towards NO₂. Consequently, O₂, NO and therefore NO₂ is substantially removed from the gas phase also. According to the present invention, a single operating step is thus disclosed which is capable of removing several contaminants present in a carbon dioxide stream, e.g. from a flue gas, which are otherwise difficult to remove almost completely, while at the same time maintaining a high carbon dioxide yield.

A further object of the present invention is to increase the yield of carbon dioxide; therefore the effect of the absorption process should be improved. First of all, the amount of waste carbon dioxide is minimized when the gaseous stream fed to the column is at a temperature above the dew point temperature of carbon dioxide at the prevailing conditions. The higher temperature of the gaseous carbon dioxide causes the bottom part of the column to function as a stripper section and the top part of the column to function as an absorption section. When the temperature of the gaseous feed stream is higher than the dew point temperature, the excess heat used for reaching the dew point is used to evaporate the incoming liquid absorbent carbon dioxide, so that the amount of carbon dioxide in the contaminant rich liquid stream leaving the scrubber is as small as possible. In other words, the liquid stream denoted L2 (in both FIGS. 1 and 2) is minimized when the temperature of the gaseous feed stream is higher than the dew point temperature of carbon dioxide.

The pressure in the column is normally between 10 and 40 bar, however, other pressures are contemplated, for example if the temperature of the liquid absorbent carbon dioxide is higher than the freezing temperature of water under the prevailing pressure, the carbon dioxide would also be able to remove water from the stream. In the above set up, a preferred temperature range of the gaseous feed stream is 5 to 25° C., more preferred 5 to 15° C., such as 10° C., although temperatures in the range of −40 to 40° C. are contemplated if operating at another pressure. The dew point temperature of carbon dioxide in the above mentioned pressure range is −40 to +5.5° C.; it is within the skill of the art to determine the dew point temperature of carbon dioxide at any given pressure.

Furthermore, the improvement of the absorption process will be a compromise between sufficiently high removal of contaminants and minimizing the spent carbon dioxide absorbent. Operating plants seek at the same time to increase purity and carbon dioxide yields. As the temperature of the liquid absorbent carbon dioxide is essentially constant in the absorption column of a given process, the flow of the liquid absorbent carbon dioxide can be varied for improved results.

A suitable flow is determined by various factors that may result in the same desired degree of purification and yield. Examples of factors that influence the process are the heat transfer capacity of the streams and the temperature of the streams entering the absorber. As the aim is to obtain a high yield of pure carbon dioxide it is desired that the flow of the absorbent liquid carbon dioxide, is at such a rate that not more than 5% (by weight) contaminant rich carbon dioxide is discarded from the bottom of the absorber as compared to the carbon dioxide content of the gaseous feed stream fed to the absorption column; the upper limit of 5% is set out of an economical point of view. Technically, higher percentages are also contemplated, however, in practice if operating at higher rates, there should be provisions for recovering the “waste” contaminant rich carbon dioxide stream again, such as the use of a reboiler. A reboiler can be integrated in the absorption column or connected to or near the bottom section of the absorption column. In this embodiment, the “waste” stream of liquid carbon dioxide comprising absorbed impurities, i.e. the contaminant rich stream, is either recirculated, e.g. to a heat exchanger, and the now gaseous stream may re-enter the absorber for purification again, or collected in a reservoir for recovery by batch distillation, or if there is a high continous flow, by distillation of the “waste”/contaminant rich stream.

When the contaminant rich liquid carbon dioxide is re-evaporated some of the impurities will remain in the liquid phase, consequently, the re-evaporation may be considered as a further means for reducing the amount of liquid waste generated.

Therefore, another embodiment of the invention discloses a method for removing at least one contaminant from a gaseous feed stream substantially comprising carbon dioxide, said method comprising the step of subjecting the gaseous feed stream to an absorption step, the absorbent being liquid carbon dioxide, wherein the contaminant rich liquid carbon dioxide leaving at the bottom section of the column is re-evaporated and fed to the absorber again.

In this embodiment, the desired purification is still obtained. Additionally, the amount of waste carbon dioxide is minimized without the need for having any specific temperature of the gaseous carbon dioxide feed stream. This would be of particular interest in two scenarios; one in which the flow of liquid absorbent carbon dioxide is relatively high so as to give a substantial amount of waste liquid flow. Also, it is applicable when the gaseous feed stream due to prior operating steps has a very low temperature close to or lower than the dew point of carbon dioxide at the prevailing conditions. It should also be emphasized that though it is desired to minimize the waste liquid flow, i.e. the amount of carbon dioxide in the contaminant rich stream, the liquid absorbent carbon dioxide flow must be high enough to generate a liquid stream leaving at the bottom of the column. Thus, at a certain pressure in the column there will be a specific lower limit for the flow rate of liquid absorbent carbon dioxide. For example, looking at table 1 when the pressure is 22.8 bar and the temperature of the gaseous feed stream entering the column is approximately 10° C., the lower limit of the liquid absorbent carbon dioxide flow appear to be approximately 400 kg/hour. More specifically the minimum amount of carbon dioxide of the contamint rich liquid stream is reached when the available heat of evaporation is less than the heat required to cool the gaseous feed stream in order for it to reach its dew point temperature.

The above considerations will now be illustrated without limitation to this specific example where the flow of the liquid absorbent carbon dioxide results in a ratio of carbon dioxide in the “waste” contaminant rich stream to the gaseous feed stream of at the most 5%. In a facility running at 10 tons/hour gaseous feed stream, the flow of the liquid absorbent would have to be 1 ton/hour when the temperature difference between gas and liquid is 25° C., this gives a ratio of around 3%, i.e. the content of carbon dioxide in the “waste” contaminant rich stream to the content of carbon dioxide in the gaseous feed stream.

In theory most contaminants might be able to be removed using liquid carbon dioxide as an absorbent however, under industrial applicable conditions for high purity carbon dioxide plants the ratio of liquid carbon dioxide stream to the feed stream should be in the range of 1/11 to ½, preferably 1/11-⅓, such as 1/9, 1/7 or ¼.

The ratio of liquid carbon dioxide to feed stream depends on the contamint profile and the amounts of each of the at least one contaminant(s).

In a presently preferred embodiment, the absorbent is liquid carbon dioxide originating from the gaseous feed stream to be purified. In this embodiment the absorber, in which the method is taking place, is provided with a condensing means, preferably in the top section of the absorption column. When the gaseous carbon dioxide feed stream contacts the condensing means, a fraction of the gas will condense and, due to the higher density, run in the opposite direction than the gaseous stream and acts as the absorbent. This construction has several advantages; first of all, the set up is relatively simple and the absorbent is a part of the gaseous stream to be purified. The energy used for running the condenser would be externally supplied. However, in this embodiment, impurities may eventually build up in the overhead gas phase.

In another presently preferred embodiment, the absorbent is an externally supplied source of liquid carbon dioxide, particularly preferred a stream from the down stream carbon dioxide purification process. The carbon dioxide stream may in this embodiment be distilled liquid carbon dioxide. The advantage of this embodiment is that the absorbent, which is used in the column, has a higher purity; consequently, there will be no accumulation of impurities in the gaseous phase above the absorber, and additionally the flow of liquid absorbent carbon dioxide may be reduced as compared to the above mentioned embodiment. Moreover, the carbon dioxide of higher purity will have improved absorbing properties. This is particularly advantageous in facilities where a potential build up of contaminants occur frequently using the first mentioned embodiment, even when contaminants are present in smaller amounts.

In another aspect and/or embodiment is provided a method for removing at least one contaminant from a gaseous feed stream substantially comprising carbon dioxide, said method comprising the step of subjecting the gaseous stream to an absorption step in an absorption column having a top, bottom and an intermediate section, wherein the absorbent is liquid carbon dioxide and wherein the absorption step comprises an integrated dehydration step, in which the dehydration step is performed at a temperature above the freezing point of water under the prevailing conditions. This will prevent that the water freezes prior to being mixed with the water inhibitor. In yet another embodiment the at least one contaminant is selected from the group consisting of non-polar organic compounds or compounds having a boiling point higher than the boiling point of carbon dioxide and there is provided a carbon dioxide enriched gaseous stream and a contaminant enriched liquid stream comprising at least 95% (w/w) of each of the at least one contaminant(s).

The gaseous feed stream comprising water is contacted with an agent capable of decreasing the water activity (a water inhibitor, a dehydrating agent), herein after “the water inhibitor”. Such a water inhibitor is preferably fed in the absorber at a location between the mid section of the absorption column and above the inlet of the feeding gas; in this context mid-section should be understood as being “mid” relative to the height of the absorber/scrubber, i.e. the center part of the intermediate section. As mentioned the temperature at the bottom of the column will be adjusted so that water does not freeze under the prevailing conditions. However, once being mixed with the water inhibitor, the freezing point is significantly reduced why the temperature is no longer as critical. Alternatively the water inhibitor may be fed at the same position as the feed stream or together with the feed stream, depending on the temperature of the feed stream. The term water inhibitor contemplates any agent capable of decreasing the water activity/inhibit water and may be selected from the group consisting of methanol, ethanol, mono ethylene glycol and tri ethylene glycol. Methanol and ethanol are particularly preferred. Due to the low temperature in the absorber, it is desired to select a water inhibitor that has a low viscosity under the prevailing conditions. Furthermore, it is desired to choose water inhibitors that are relatively inexpensive and easy to recover; recovery of the water inhibitor, e.g. methanol and ethanol is within the skill of the art. Ethanol may be preferred, if the process is implemented in a bio-ethanol plant or a similar plant in which fermentation takes place i.e. where the water inhibitor, ethanol, is present at the facility so that no external supply of water inhibitor is needed; the water inhibitor may thus in a particular preferred embodiment be bio ethanol.

When having an integrated dehydration step saving of space is even more improved as an upstream-located dehydration step, often employed, may now be omitted.

The absorbed water and water inhibitor is preferably drawn from the absorber at the bottom of the column along with the contaminant rich liquid carbon dioxide stream.

In this embodiment, the contaminant rich liquid carbon dioxide fraction may also leave the column at a point higher than the inlet of the water inhibitor into the column, e.g. between the water inhibitor inlet and the mid-section of the column, in order to obtain a methanol poor carbon dioxide fraction that may be returned to the absorption column, preceded by an evaporation step, e.g. in a re-boiler.

In yet another embodiment a fraction of the contaminant rich liquid stream comprising the water inhibitor and absorbed impurities is circulated in a loop. In this embodiment the contaminant rich liquid stream leaving at the bottom section of the absorption column is split in two so that a first fraction of the liquid stream (L2′ in FIG. 2) is recirculated to the inlet of pure water inhibitor and mixed therewith. This saves consumption of water inhibitor in the over all process by exploiting the full ability of the water inhibitor to bind water. In a typical process according to the present invention, the water content is relatively low as compared to the capability of any of the above mentioned water inhibitors to absorb water; therefore looping the water inhibitor so that the water in the gaseous feed stream is inhibited by the water inhibitor mixed with water, carbon dioxide and impurities as defined in the context of the present invention, will not impair the water inhibiting ability. Rather the ability of the water inhibitor to bind water is fully exploited.

It is also contemplated that all of the above embodiments may be combined, i.e. that both an intermediate outlet for liquid carbon dioxide in the upper part of the absorption column, and/or a loop of waste liquid and/or a split loop of waste liquid may be present.

If the feeding gas comprises O₂, NO and NO₂, NO₂ could also be absorbed in the liquid CO₂. This would force the gas phase equilibrium ½O₂+NO<->NO₂ to the right. Consequently, substantial amounts of the NOx's would be removed from the stream as NO₂ in the liquid CO₂ leaving at the bottom of the absorber. As mentioned, NO₂ favours liquid carbon dioxide; once substantially pure liquid carbon dioxide is obtained NO₂ is very difficult to separate off. By introducing the carbon dioxide absorber/scrubber, i.e. the absorption column, gaseous streams comprising trace amounts of NOx's are additionally removed there from.

As the methods of the present invention is to be performed in an operating unit located within a larger unit, the methods are in a particular embodiment followed by processing the purified gaseous carbon dioxide leaving the absorption column by optionally heat exchange, optionally filtration, such as using a carbon filter, and finally distillation, e.g. flash distillation, in order to give a pure liquid carbon dioxide product to be stored and sold. The method of the present invention therefore also contemplates the product carbon dioxide obtained after purification using the claimed methods. Likewise it is contemplated that upstream purification steps may be present, such as a condensation step in which a CO2-rich gas and liquid is obtained followed by the absorption step according to the present invention.

In yet another aspect the present invention provides a carbon dioxide purification unit, which in one embodiment is illustrated in FIG. 3, comprising an absorption column A1 having a top and a bottom and a section intermediate of the top and the bottom, the absorption column having a feeding gas inlet g1 at the bottom of the column below the product gas outlet g2, a product gas outlet g2 situated at the top of the column, a liquid carbon dioxide inlet l1 situated at the top of the column, a waste liquid outlet l2 situated at the bottom part of the column and a water inhibitor liquid inlet l0 situated above the feeding gas inlet g1 and below the liquid carbon dioxide inlet l1. This unit is particularly useful for operating the method of the present invention. The positioning of the inlets and outlets allows for optimal purification of a wet gaseous stream using a liquid e.g. liquid carbon dioxide.

The absorption column may be any absorption column known in the art, which is suitable for the particular purpose. Size and dimensions vary depending on the size of the carbon dioxide purification plant. The choice of absorption column is within the skill of the art. Pipes, pumps, valves etc. are also included and the specific choice of and location of such additional elements is within the skill of the art. The intermediate section may be a packed section or if a tray column trays.

In a particular embodiment, the contaminant rich liquid outlet l2 situated at the bottom of the column is split in two at a position outside the column and one pipe l2′ is fed to the water inhibitor inlet pipe l0, and the other pipe l2″ is fed to disposal. This provides for recycling of the water inhibitor. The branching of the pipe allows the stream to proceed in two ways. A valve may control the flows in either direction.

In another particular embodiment, the absorption column is further provided with a carbon dioxide outlet l5 situated at a position between the water inhibitor inlet l0 and the liquid carbon dioxide inlet l1.

If an outlet is positioned above the inlet where the water inhibitor is fed to the absorption column, liquid carbon dioxide, essentially without water inhibitor may exit the column for further purification, e.g. being recycled to the absorption column.

In yet another embodiment, in which the purification unit is connected to the respective up and downstream operating units the feeding gas inlet g1 is connected to a feeding gas source, preferably partially purified carbon dioxide; and/or the product gas outlet g2 is connected to a carbon dioxide processing unit, such as a heat exchanger and/or a filter and/or a distillation column; and/or the liquid carbon dioxide inlet l1 is connected to a liquid carbon dioxide reservoir, e.g. the distillation column connected to the product gas outlet; and/or the waste liquid outlet l2 is connected to a waste reservoir and/or the water inhibitor inlet; and/or the water inhibitor liquid inlet l0 is connected to a water inhibitor reservoir.

In still another embodiment, the carbon dioxide outlet l5 is connected to a carbon dioxide purification unit, such as the absorption column A1. This embodiment reduces the amount of liquid carbon dioxide that may be mixed with the water inhibitor. As it may be difficult to remove the water inhibitor from the waste liquid stream, this will be of importance if substantial amounts of carbon dioxide is present in the waste liquid.

### FIGURES

FIG. 1 is a flow scheme embodying the process of the invention where the influent gas does not comprise water.

FIG. 2 is a flow scheme embodying the process of the invention where the influent gas comprises water.

FIG. 3 is a schematic illustration of an embodiment of the carbon dioxide purification unit of the present invention.

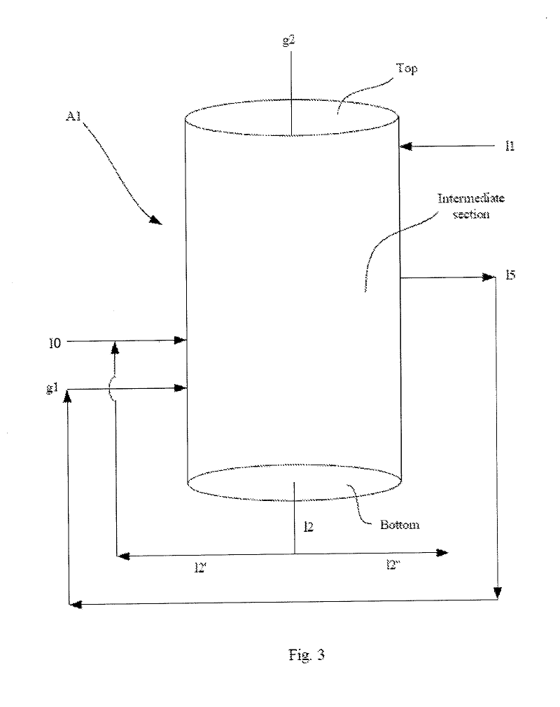

### DETAILED DESCRIPTION OF THE INVENTION

According to the present invention, a substantially pure CO₂ stream comprises more than 80 weight-% CO₂.

Throughout the description, unless otherwise indicated, all contents are given as weight-%.

Throughout the description and the claims the terms impurity and contaminant may be used interchangeably having the same meaning in the context of the present invention and both cover undesired substances in a carbon dioxide stream that should be removed.

Throughout the description and the claims the terms water activity reducing agent, agent and water inhibitor may be used interchangeably having the same meaning in the context of the present invention, and all cover a substance that is capable of removing water from a carbon dioxide stream.

Throughout the description and the claims the term water free or dry gaseous stream is a gaseous stream in which the water content is so low so as not to cause process related problems, such as freezing within pipes, containers etc. More specifically a water free or dry gaseous stream may be defined as a stream wherein the dew point temperature of water is lower than the temperature under the prevailing process conditions.

The absorption process described in greater details below typically takes place in a traditional absorber of the scrubber type. The specific choice of scrubber depends on the size of the facility and other factors; this is within the skill of the art.

All illustrations appended to the present description should be understood as a section of a larger facility. All features and variants of each of the embodiments and aspects described herein apply equally to all embodiments.

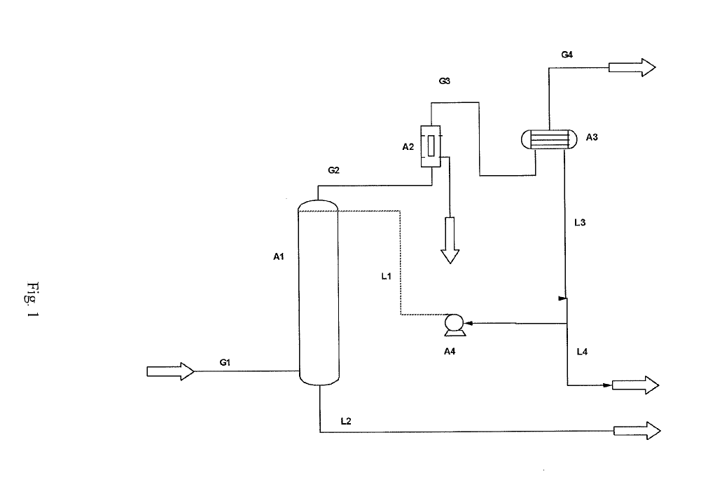

Referring now to FIG. 1, an embodiment of the present invention is illustrated in which the influent gaseous feedstream G1 is water free. The scheme shows an absorber A1, a filter A2, a condenser or distillation column A3 and a pump A4. The streams shown are the gaseous feed stream G1 fed at the bottom of the absorber, a carbon dioxide enriched gas G2 leaving at the top of the absorber, a filtered gas G3 leaving the filter A2 and being fed to the condenser A3 in which the gas is condensed to give a substantially pure liquid carbon dioxide stream L3 and a gaseous mixture of carbon dioxide and non-condensable gases G4; G4 may be further purified. L3, the condensed and/or distilled essentially pure carbon dioxide stream is divided in two streams L1 and L4, respectively. L1 is fed to the absorber as the liquid absorbent carbon dioxide stream, and L4 is stored or further processed. In the embodiment where the absorbent is created within the absorption column this stream would not be divided but simply constitute L4. L2 is the “waste”/contaminant rich liquid carbon dioxide stream comprising the absorbed/washed/scrubbed out contaminants. The stream L2 is either disposed of, or if constituting substantial volumes, e.g. when the gaseous feed stream enters the column at, near or below its dew point temperature, passed through a heat exchanger (not shown) and fed to the gaseous feed stream G1 for another cycle of purification (not shown). This heat-exchanging step will evaporate primarily carbon dioxide and consequently, the impurities will be concentrated in the liquid waste, the volume of which is now minimized.

Before entering the absorption column A1, the gaseous feed stream G1 will typically be passed through a filter and/or a heat exchanger in order to condition the stream G1 for entering A1 at the bottom of the column. It is desired to prepare the gaseous stream G1 so that the temperature is well above the dew point temperature of carbon dioxide at the given conditions. The pressure in the absorber will typically be around 6 to 25 bar in the food and beverage industry, such as between 15 and 23 bar, e.g. 22.8 bar. In other applications, pressures are, however, also contemplated such as up to 60 bar, e.g. 40 to 55 bar, or even higher. The dew point temperature of carbon dioxide at 10 bar is −40° C., therefore, the temperature of the stream entering the column should preferably be higher than this temperature. When the appropriate pressure has been chosen it is within the skill of the art to choose the appropriate temperature of the feeding gas. When the temperature of the gaseous feed stream is well above the dew point of carbon dioxide when entering the column, the amount of liquid carbon dioxide in the bottom stream is minimized. Additionally, by feeding a, in the context of carbon dioxide, warm gaseous stream into the column the (excess) heat is used to evaporate the incoming liquid L1 so that the amount of carbon dioxide comprised in the liquid L2 is minimized. In general, the present inventors have found that the volume of L2 is minimised when the temperature of G1 is higher than L2. If a gaseous stream, contrary to the present invention, comprises other desirable products than carbon dioxide it would be preferable to decrease the temperature of the feeding gas G1 to near the dew point of carbon dioxide in order to minimize the content of carbon dioxide in the product stream G2. If the feeding gas is fed at the dew point temperature of carbon dioxide the liquid waste may be re-evaporated and part of the carbon dioxide recycled to the process, such as to the feeding gas.

It is also contemplated that the gaseous feed stream is cooled before entering the absorption column in that embodiment the contaminant rich liquid stream will comprise substantial amounts of carbon dioxide and therefore a reboiler should be present.

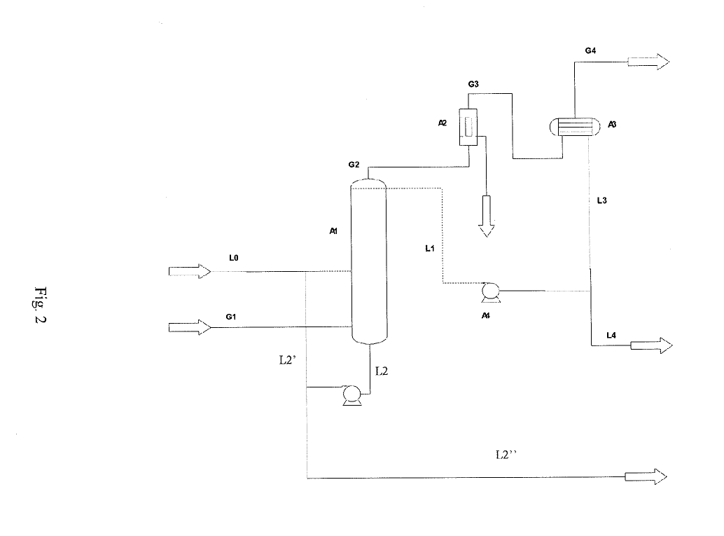

Referring now to FIG. 2 an embodiment of the present invention is illustrated in which the influent gaseous feed stream G1 comprises water, i.e. is wet. In FIG. 2 the denotations given in FIG. 1 are the same. Additionally, in FIG. 2 is shown a liquid stream L0 entering the column at a position above the feeding gas G1 and below the mid section of the column. The stream L0 comprises the water inhibitor, e.g. methanol, ethanol, mono ethylene glycol or tri ethylene glycol and is therefore a water inhibitor feed stream. It is also contemplated that L0 is fed together with or at the same position as G1 or is mixed with G1 before entering the column.

The contaminant rich liquid stream L2 leaving at the bottom of the column is in the embodiment shown in FIG. 2 split into the streams L2′ a first contaminant rich stream and L2″, a second contaminant rich stream. L2″ is discarded or recovered. L2′ is mixed with the stream L0 and re-enters the column in a mixture as the water inhibitor. L2′ comprises carbon dioxide, contaminants, water and the water inhibitor feed stream. This looping of the water inhibitor is feasible despite the fact that pure inhibitor is mixed with the first contaminant rich liquid stream L2′ because pure inhibitor will most likely have a water binding capacity which often by far exceeds the amount of water present in the gaseous feed stream G1. Therefore, by looping the liquid stream L2′ to the stream L0, consumption of water inhibitor and the volume of the first contaminant rich stream of L2′ will be reduced both resulting in overall savings. The ratio of the first contaminant rich stream L2′ that is mixed with the water inhibitor feed stream L0 to the contaminant rich stream L2 depends on the water inhibitor used. The skilled person will be able to determine the optimal ratio without undue burden. It is also contemplated that liquid carbon dioxide may be withdrawn at a position above the inlet of the water inhibitor. This stream is denoted L5 in FIG. 2. The advantage of this embodiment is that the water inhibitor is not contaminated with an impurity from which the water inhibitor cannot be recovered.

It is, however, also contemplated by the present invention that the entire contaminant rich stream leaving at the bottom of the absorber is discarded, i.e. the stream L2′ is not mixed with L0 and fed to the absorber again. This embodiment may be desirable if unexpectedly large amounts of water are present in G1 or if the stream L0 is diluted beforehand so that the concentration of water inhibitor is low. Another situation where L2′ is not mixed with LO could be if the stream (L2′) comprises contaminants which react with the water inhibitor creating undesired biproducts.

The flow rate of L1 must as mentioned above be high enough to give a stream L2. The cooling capacity of the stream L1 should therefore be high enough to cool both G1 and, if present, L0 to give water free G2.

The present invention will now be illustrated in more details by way of the following non-limiting example.

Purification of gaseous carbon dioxide according to the method of the present invention at a constant pressure of 22.8 bar in the column, at a constant feeding gas temperature of 10.70° C. and at a constant liquid carbon dioxide temperature of −18.20 ° C. is illustrated in the table below with varying flow rates of the liquid absorbent carbon dioxide stream. The number given in the column TB (° C.) is the boiling point of each of the components under 1 bar(a).

| | | Liquid CO₂ fed to column (Kg/h) | | | | | | | | |
|---|---|---|---|---|---|---|---|---|---|---|
| | | 2000 | 1500 | 1250 | 1150 | 1050 | 600 | 500 | 400 | |
| Flow rates (kmole/h) | Feed gas | % Recovery to waste liquid outlet | | | | | | | | TB ° C. |
| Nitrogen | 0.01 | 1.43 | 0.97 | 0.75 | 0.65 | 0.56 | 0.15 | 0.06 | 0.00 | −195.8 |
| Oxygen | 0.01 | 2.68 | 1.83 | 1.41 | 1.23 | 1.06 | 0.30 | 0.13 | 0.01 | −182.98 |
| Methane | 0.01 | 3.15 | 2.15 | 1.65 | 1.45 | 1.25 | 0.35 | 0.15 | 0.01 | −161.49 |
| Carbon Dioxide | 100.00 | 24.41 | 18.07 | 14.47 | 12.95 | 11.36 | 3.47 | 1.53 | 0.06 | −78.48 |
| Hydrogen Sulfide | 0.01 | 43.41 | 30.14 | 23.29 | 20.53 | 17.77 | 5.28 | 2.49 | 0.19 | −60.35 |
| Carbonyl Sulfide | 0.01 | 95.43 | 86.96 | 77.41 | 71.93 | 65.30 | 21.36 | 9.52 | 0.32 | −50.15 |
| Ammonia | 0.01 | 96.40 | 89.22 | 80.58 | 75.41 | 68.98 | 22.93 | 10.08 | 0.35 | −33.43 |
| Dimethyl Ether | 0.01 | 99.87 | 99.46 | 98.71 | 98.09 | 97.07 | 67.01 | 37.51 | 0.66 | −24.84 |
| n-Pentane | 0.01 | 99.90 | 99.60 | 99.03 | 98.55 | 97.78 | 74.15 | 49.36 | 1.81 | 36.07 |
| Nitrogen Dioxide | 0.01 | 100.00 | 100.00 | 99.99 | 99.99 | 99.98 | 99.56 | 98.04 | 2.72 | 20.85 |
| n-Hexane | 0.01 | 100.00 | 100.00 | 99.99 | 99.99 | 99.98 | 99.61 | 98.52 | 5.01 | 68.73 |
| Acetaldehyde | 0.01 | 100.00 | 100.00 | 100.00 | 100.00 | 100.00 | 99.98 | 99.89 | 4.81 | 20.85 |
| Ethyl Acetate | 0.01 | 100.00 | 100.00 | 100.00 | 100.00 | 100.00 | 99.99 | 99.98 | 61.40 | 77.06 |
| Dimethyl Sulfide | 0.01 | 100.00 | 100.00 | 100.00 | 100.00 | 100.00 | 100.00 | 99.99 | 10.61 | 37.33 |
| Benzene | 0.01 | 100.00 | 100.00 | 100.00 | 100.00 | 100.00 | 100.00 | 100.00 | 60.87 | 80.09 |
| Acetone | 0.01 | 100.00 | 100.00 | 100.00 | 100.00 | 100.00 | 100.00 | 100.00 | 69.76 | 56.25 |
| Toluene | 0.01 | 100.00 | 100.00 | 100.00 | 100.00 | 100.00 | 100.00 | 100.00 | 99.40 | 110.63 |
| Methanol | 0.01 | 100.00 | 100.00 | 100.00 | 100.00 | 100.00 | 100.00 | 100.00 | 99.71 | 64.7 |
| Ethanol | 0.01 | 100.00 | 100.00 | 100.00 | 100.00 | 100.00 | 100.00 | 100.00 | 99.88 | 78.29 |
| Isobutanol | 0.01 | 100.00 | 100.00 | 100.00 | 100.00 | 100.00 | 100.00 | 100.00 | 99.99 | 107.66 |
| n-Propanol | 0.01 | 100.00 | 100.00 | 100.00 | 100.00 | 100.00 | 100.00 | 100.00 | 100.00 | 97.2 |
| Feed gas temp ° C. | 10.70 | | | | | | | | | |
| Gas Outlet temp ° C. | | −19.01 | −19.01 | −19.00 | −19.01 | −19.00 | −18.97 | −18.95 | −17.68 | |
| Liquid Feed temp. ° C. | −18.20 | | | | | | | | | |
| Liquid outlet temp. ° C. | | −18.83 | −18.75 | 18.74 | −18.75 | −18.57 | −17.66 | −16.28 | 5.24 | |
| Liquid outlet flow of CO₂. | | 35.51 | 24.22 | 18.58 | 16.33 | 14.07 | 3.95 | 1.70 | 0.07 | |
| kmole/hr | | | | | | | | | | |
| % CO₂ loss | | 78.14 | 71.07 | 65.43 | 62.49 | 58.99 | 28.96 | 14.97 | 0.74 | |
| of liquid inlet^{a} | | | | | | | | | | |
| % CO₂ loss | | 24.41 | 18.07 | 14.47 | 12.95 | 11.36 | 3.47 | 1.53 | 0.06 | |
| of total CO₂ amount^{b} | | | | | | | | | | |

^{a}The percentage CO₂ loss of liquid inlet is calculated as the molar flow of liquid CO₂ leaving the column divided by the kg CO₂ fed to the column divided by the molar mass of CO₂ (i.e. 44 g/mole) and multiplied by 100.
^{b}The percentage CO₂ loss of total CO₂ amount is calculated as the molar flow of liquid CO₂ leaving the column divided by the sum of the gas and liquid inlet (kg liquid CO₂ divided by 44 kmole gas) and multiplied by 100.

The gaseous feed stream G1 is fed to the bottom of the absorption column at a flow of approximately 100 kmole/hour. The major component is carbon dioxide contaminated with minor amounts of the components as indicated in the table.

The liquid absorbent carbon dioxide stream L1 is fed at the top of the absorption column at different flow rates in the range 400-2000 kg/hour as indicated in the table above.

In the column the gaseous stream passes through the cooler liquid stream undergoing heat exchange whereby constituents of the gaseous stream will start to condense. As the contaminants have an apparent higher temperature of liquefaction under the prevailing conditions these will condense more easily than carbon dioxide and consequently be mixed with the liquid.

The contaminant rich liquid L2 leaves the absorption column at the bottom section and is discarded or re-boiled and fed to the gaseous feed stream again and fed to the absorption column.

The gaseous carbon dioxide enriched stream leaves the column at the top section and is to be stored or further processed before being stored, e.g. by filtration and distillation.

From the table it is evident that under the above conditions the lowest applicable flow rate of liquid carbon dioxide is approximately 400 kg/h. As mentioned previously, it is important that the flow is sufficient to give a liquid waste flow, otherwise no components would be scrubbed out. At this flow rate only n-propane is completely reduced; toluene, methanol, ethanol and iso-butanol to over 99%.

Increasing flow rates increases the number of components that are washed out. Thus, depending on the composition of the feed gas the flow rate can be adjusted for optimal results.

As one of the objects of the invention was to reduce the waste liquid carbon dioxide, at this particular set up, the method would at a flow rate higher than about 600 kg/hour, be performed according to the embodiment of the invention in which the waste liquid is re-circulated to the feed gas, usually after a re-boiling step. At a flow rate of 600 kg/hour the 3.47% carbon dioxide of the total carbon dioxide balance is in the liquid waste stream.

1. A method for removing at least one contaminant from a gaseous feed stream substantially comprising carbon dioxide, said method comprising the step of subjecting the gaseous feed stream to an absorption step in an absorption column having a top, bottom and an intermediate section, wherein the absorbent is liquid carbon dioxide and wherein the at least one contaminant is selected from the group consisting of non-polar organic compounds or compounds having a boiling point higher than the boiling point of carbon dioxide under conditions whereby a carbon dioxide enriched gaseous stream and a contaminant rich liquid stream containing at least 95% (w/w) of the at least one contaminant from the gaseous feed stream, is obtained,
wherein the temperature of the gaseous feed stream entering the column is higher than the dew point temperature of carbon dioxide at the prevailing absorption conditions and the ratio of absorbent to gaseous feed stream is at least 1/11.

2. The method according to claim 1, wherein the at least one contaminant is selected from the group consisting of oxygenates, esters, aromatic compounds and alcohols.

3. The method according to claim 1, wherein the ratio of absorbent to gaseous feed stream is in the range 1/11 to ½, and wherein the at least one contaminant is selected from the group consisting of oxygenates, esters, aromatic compounds and alcohols.

4. The method according to claim 1, wherein the absorbent is an externally supplied source of pure liquid carbon dioxide.

5. The method according to claim 1, wherein the absorption step further comprises an integrated dehydration step.

6. The method according to claim 1, wherein the absorption step further comprises an integrated dehydration step wherein the dehydration step is performed using a water inhibitor, which decreases the water activity in the gaseous feed gas, wherein the water inhibitor is selected from the group consisting of such as methanol, ethanol, mono ethylene glycol and tri ethylene glycol.

7. The method according to claim or 6, wherein the water inhibitor used in the dehydration step is recirculated.

8. The method according to claim 6, wherein the water inhibitor is fed to the intermediate section of the absorption column at a position higher than a position where the gaseous feed stream is fed to the absorption column.

9. The method according claim 8, wherein the water inhibitor is fed to the intermediate section of the absorption column at a position higher than a position where the gaseous feed stream is fed to the absorption column and, wherein the liquid carbon dioxide is partially withdrawn from the absorption column at a position above the inlet of the water inhibitor.

10. The method according to claim 1, wherein the contaminant rich liquid carbon dioxide stream comprising contaminants leaving the bottom section of the column is evaporated and fed to the gaseous stream entering the absorption column.

11. The method according to claim 1, further comprising the steps of:
optionally heating the purified gaseous carbon dioxide stream leaving the absorption column,
optionally filtrating the purified gaseous carbon dioxide stream, and
condensing and/or distilling the purified carbon dioxide stream to provide a high purity liquid carbon dioxide stream.

12. A carbon dioxide purification unit comprising an absorption column (A1) having a top and a bottom and a section intermediate of the top and the bottom, the absorption column having a feeding gas inlet (g1) at the bottom of the column, a product gas outlet (g2) situated at the top part of the column, a liquid carbon dioxide inlet (l1) situated at the top part of the column, a waste liquid outlet (l2) situated at the bottom part of the column wherein the absorption column further comprises a water inhibitor liquid inlet (l0) situated above the feeding gas inlet (g1) and below the liquid carbon dioxide inlet (l1).

13. The unit according to claim 12, wherein the waste liquid outlet (l2) situated at the bottom of the column is split in two at a position outside the column and one pipe (l2′) is fed to the water inhibitor inlet pipe (l0) and the other pipe is fed to disposal (l2″).

14. The unit according to claim 12, wherein the column is further provided with a carbon dioxide outlet (l5) situated at a position between the water inhibitor inlet (l0) and the liquid carbon dioxide inlet (l1).

15. The unit according to claim 12, wherein the feeding gas inlet (g1) is connected to a feeding gas source, preferably partially purified carbon dioxide; and/or the product gas outlet (g2) is connected to a carbon dioxide processing unit, such as a heat exchanger and/or a filter and/or a distillation column; and/or the liquid carbon dioxide inlet (l1) is connected to a liquid carbon dioxide reservoir, e.g. the distillation column connected to the product gas outlet; and/or the waste liquid outlet (l2) is connected to a waste reservoir; and/or the water inhibitor inlet; and/or the water inhibitor liquid inlet (l0) is connected to a water inhibitor reservoir.

16. The unit according to claim 15, wherein the carbon dioxide outlet (l5) is connected to the feeding gas inlet.

17. The method according to claim 1, wherein the ratio of absorbent to gaseous feed stream is in the range 1/11 to ⅓ and wherein the at least one contaminant is selected from the group consisting of oxygenates, esters, aromatic compounds and alcohols.

18. The method according to claim 4, wherein the absorbent is a stream from a down stream purification process of the same overall process
